(19) United States
(12) Patent Application Publication
(10) Pub. No.: US 2014/0030024 A1
(43) Pub. Date: Jan. 30, 2014

(54) APPARATUS AND COMPONENT FOR REMOVING PIPES

(71) Applicant: Jacobus Hendrik Cilliers, Birmingham (GB)

(72) Inventor: Jacobus Hendrik Cilliers, Birmingham (GB)

(21) Appl. No.: 14/111,497

(22) PCT Filed: Apr. 3, 2012
(86) PCT No.: PCT/GB2012/050751

§ 371 Date: Oct. 11, 2013

(30) Foreign Application Priority Data
Apr. 12, 2011 (GB) 1106144.7

(51) Int. Cl. F16L 1/032; F16L 1/06

(52) U.S. Cl. CPC F16L 1/032; F16L 1/06
USPC 405/154.1

(57) ABSTRACT

This invention relates to an improved apparatus and component for removing (and perhaps replacing) pipes, in particular underground pipes, as suitable for use in trenchless pipe removal methods such as that of WO 2008/071997. The invention provides a component which is securable to a cable, and which has a sleeve for surrounding an end of the pipe. The component has an opening through which a settable fluid may be delivered into the pipe in use. A surface of the component is adapted to seal the end of the pipe so that the settable fluid may not leak from the pipe before it has set. The apparatus comprises the component, a cable secured to the component, a winch and a settable fluid.

### FIELD OF THE INVENTION

This invention relates to an improved apparatus and component for removing pipes, in particular underground pipes. A replacement pipe may be introduced as the existing pipe is being removed.

International patent application WO 2008/071997 discloses a trenchless method and apparatus for removing and replacing underground pipes (i.e. the pipe is removed and replaced without digging a trench along the length of the pipe). The ends of the pipe which is to be removed are exposed and a cable is passed along the pipe. The cable is connected to a removal component at the end of the pipe, and a replacement pipe is also attached to the component. The component is then pulled by the cable whereby the existing pipe is pulled from the ground and the replacement pipe is inserted in its place. The application also describes the use of a settable fluid which can be injected into the existing pipe, the fluid setting prior to removal of the pipe whereby the pipe is supported during its removal and does not collapse around the cable.

The present invention provides an improved apparatus and component for use in the method described in WO 2008/071997. In order to avoid unnecessary repetition, the disclosure of WO 2008/071997 is incorporated herein.

The inventor has appreciated that an improved component is required, especially when using the settable fluid, in order to overcome problems which have arisen during practical implementations of the method of WO 2008/071997.

### SUMMARY OF THE INVENTION

According to the present invention there is provided a component for use in a trenchless method for removing a pipe, the component being securable to a cable, and having a sleeve to surround an end of the pipe, the sleeve surrounding a recess within which the end of the pipe is located in use, characterised in that the recess is adapted to seal the end of the pipe.

The improved component therefore permits the sealing of the end of the pipe whereby the settable fluid cannot leak out before it has set. Thus, a settable fluid which is introduced into the pipe which is to be replaced can be retained within the pipe until it has set sufficiently to support the pipe as the pipe is removed. The sealed end of the pipe prevents any of the settable fluid leaking from that end of the pipe. Experience has shown that if some of the settable fluid leaks from the pipe there may be insufficient settable fluid remaining to support the pipe along its full length and the pipe may collapse as it is subsequently being removed. If any part of the pipe collapses during removal the force required to remove the pipe can increase significantly, and perhaps can prevent the pipe from being removed.

Also, the sealed end of the pipe prevents air entering into the pipe to replace settable fluid which might otherwise leak out of the opposite end (the “winch end”) of the pipe. In an inclined pipe it may be that the end of the pipe to which the component is fitted is significantly higher than the end of the pipe at which the winch is located. It is recognised that the settable fluid can usually be retained within the pipe by sealing the higher end of the pipe against the ingress of air.

Preferably, the component has an opening through which the settable fluid can be introduced into the first pipe.

Desirably, a boss lies within the recess, the boss being adapted to fit inside the end of the pipe. The boss can have an opening communicating with the inside of a fitted pipe, which opening can deliver settable fluid into the pipe. Preferably, the boss is tapered. Preferably also the boss has a leading end which is of smaller diameter than the inside surface of the pipe, and a trailing end which is of larger diameter than the inside surface of the pipe. As the pipe is forced onto the boss its end is stretched around the boss whereby to form a seal therewith.

It will be understood that a settable fluid is often used with lead pipes, and lead is sufficiently ductile to deform around the boss and provide a seal therewith. The connector is also suitable for forming a seal with copper pipes, pipes of plastics such as PVC, polyurethane and MDPE (for example), and also galvanised steel.

Preferably, the tapering boss forms a reducing tapered annulus into which the end of the pipe can be forced. Ideally, as the end of the pipe is forced outwardly by the boss, it is forced into engagement with the inside surface of the sleeve, so that the end of the pipe is sealed against both the boss and the sleeve, reducing the likelihood of the leakage or air or settable fluid.

Preferably, the component has means for connection to a replacement pipe, so that the replacement pipe can be pulled into the hole from which the existing pipe is removed.

The component may be made in one-piece, for example by casting. Alternatively, the component is formed in two parts, an inner part and an outer part, a two-piece component typically being cheaper to manufacture than a one-piece component. The inner part preferably comprises a shaft which terminates at one end in the boss, and at the other end in the means for connection to a replacement pipe. The outer part preferably comprises a housing for the shaft and has a tubular end which defines the sleeve. The inner part and outer part are preferably connected together by way of cooperating threaded sections.

Preferably, the inner part has a central channel by which it is secured to an end of the cable. Ideally, the component is a single-use disposable item, designed to be disposed with the cable and the removed pipe. The inner part of the component is ideally permanently secured to the end of the cable.

The opening for the introduction of the settable fluid preferably opens into the central channel, so that the settable fluid is introduced around the cable. The cable will typically be a wire cable, the wound wire having sufficiently large gaps between adjacent flutes to permit the passage of the settable fluid. Additionally, the recess in the inner part can be stepped to provide a smaller-diameter part for securing to the end of the cable and a larger-diameter part for the passage of the settable fluid.

### BRIEF DESCRIPTION OF THE PREFERRED EMBODIMENTS

The invention will now be described in more detail, by way of example, with reference to the accompanying drawings, in which:

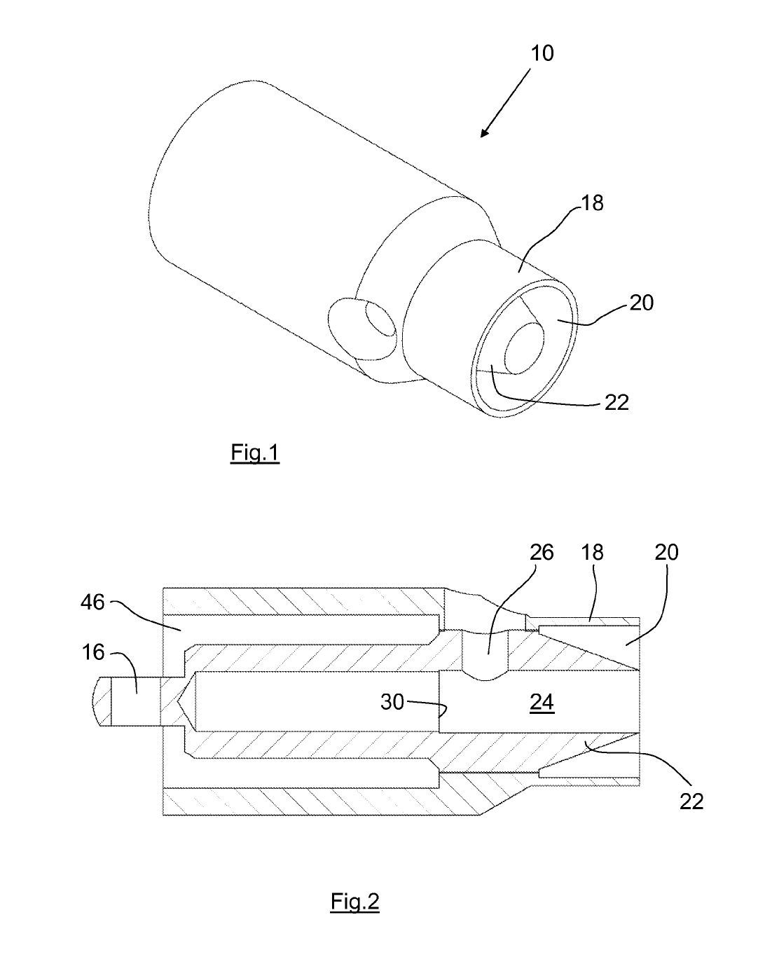

FIG. 1 shows a perspective view of the improved component of the present invention;

FIG. 2 shows a sectional view of the component;

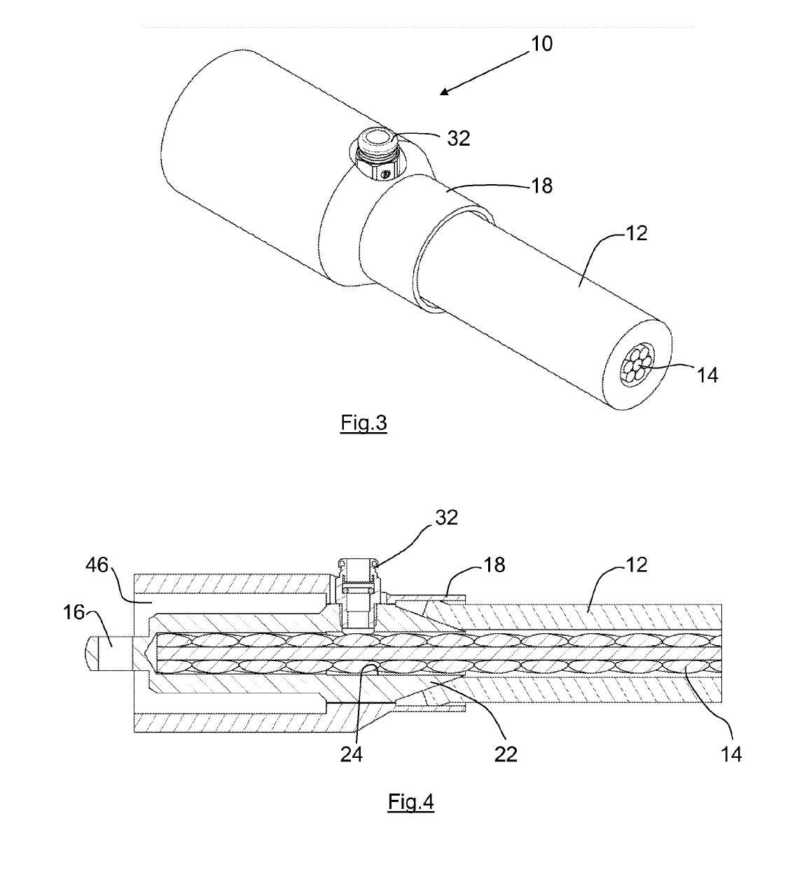

FIG. 3 shows a perspective view of the component in use;

FIG. 4 shows a sectional view of the component of FIG. 3;

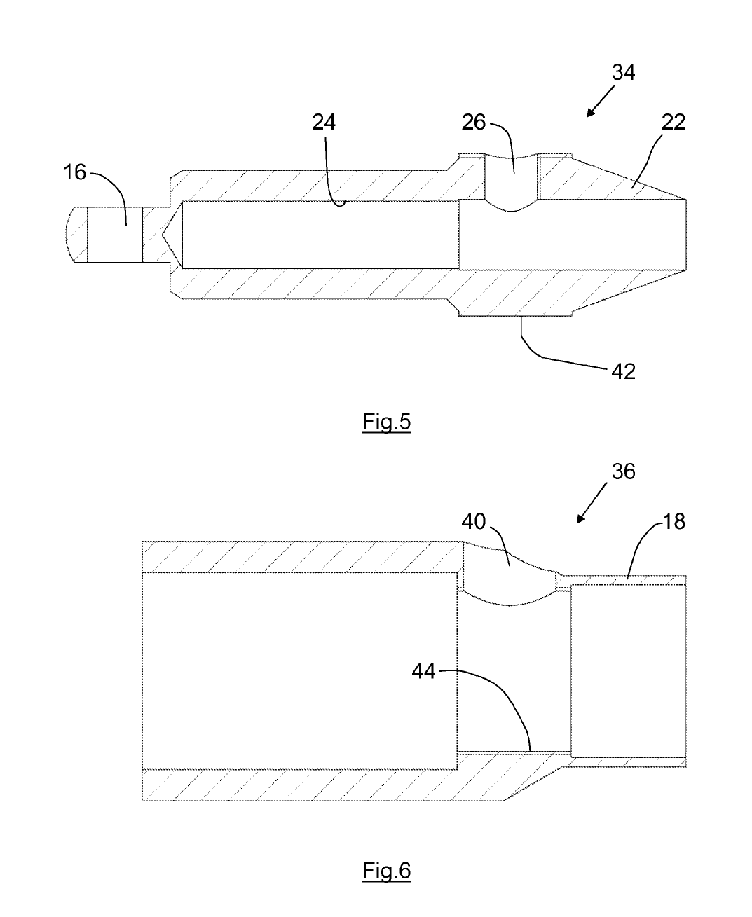

FIG. 5 shows a side sectional view of the inner part of the component; and

FIG. 6 shows a side sectional view of the outer part of the component.

### DETAILED DESCRIPTION

The improved component 10 which is shown in FIGS. 1-4 is designed for use in a trenchless method of removing an existing pipe 12 (such as a water or gas pipe serving a domestic building), and inserting a replacement pipe (not shown). As is described in WO 2008/071997, the existing pipe 12 may need to be replaced because it has become damaged for example.

Rather than removing the existing pipe 12 by excavating a trench along the length of the pipe, the component 10 is secured to a tensile cable 14 by which it may be pulled in order to remove it from the ground or other location. The component 10 has an eyelet 16 whereby it can be temporarily secured to a replacement pipe, the replacement pipe being pulled into the hole from which the existing pipe 12 is removed.

As is described in WO 2008/071997, an initial step in the method of pipe removal and replacement is to locate and open the ends of the length of pipe to be removed. Typically, when removing a water supply pipe of a domestic building for example, the pipe will be cut at a location close to its entry into the building, and also close to the stop cock where the pipe crosses the property boundary. The component 10 will typically be fitted to the “building end” of the pipe 12, and the winch (not shown) will be located at the other end of the pipe 12 (this avoids the removed pipe being pulled into the building, with the consequent dirt and debris which will accompany the pipe as it is removed). (It will be understood that the improved component can be used regardless of the locations of the exposed ends of the pipe.)

The component 10 has a sleeve 18 which surrounds a recess 20 within which the end of the pipe 12 is located. The component 10 furthermore has a boss 22 which lies within the recess 20, the boss 22 being tapered whereby the annulus within which the end of the pipe 12 is located is of reducing dimension.

As will be seen in FIG. 4 in particular, the component 10 is driven onto the end of the pipe 12 with sufficient force (as by a hammer for example) to cause the end of the pipe 12 to deform outwardly along the boss 22, the end of the pipe 12 being driven into the decreasing gap between the boss 22 and the sleeve 18. With a lead pipe in particular, the component 10 can readily be driven onto the end of the pipe 12 with sufficient force to cause the pipe to form a fluid-tight and air-tight seal against the outer surface of the boss 22 and the inner surface of the sleeve 18.

It will be understood that the seal is not required to withstand a large pressure differential, but is required to prevent the settable fluid from leaking out of the end of the pipe, and to prevent air entering the end of the pipe in the event that the pipe is inclined with the component 10 at its higher end.

The boss 22 surrounds a central channel 24 within the component 10, the central channel 24 communicating with an opening 26 through which a settable fluid may be introduced into the pipe 12.

As is clear from FIG. 4, the central channel 24 also accommodates the end of the cable 14 (in this embodiment a multi-stranded wire cable), the central channel 24 having a step 30 so as to define a narrower part which closely embraces the cable 14, and a wider part which surrounds the cable 14. The cable 14 is permanently secured to the narrower part of the central channel 24, for example by crimping, adhesive or welding, the securement being sufficient to equal or preferably exceed the tensile force of the winch by which the pipe 12 is to be removed, which tensile force might be 10 tonnes for example.

The opening 26 is threaded so as to receive a nipple 32, the nipple being adapted to accommodate a delivery pipe (not shown) for the settable fluid. As will be understood from FIG. 4 in particular, as the settable fluid is introduced through the nipple 32, it flows into the central channel 24 and around the cable 14, and along the pipe 12. The wider part of the channel 24, and the fluted form of the cable 14, provide sufficient clearance for the settable fluid to flow along the pipe 12 and fill up the gap between the pipe 12 and the cable 14.

As seen in FIGS. 5 and 6, in this embodiment the component 10 comprises an inner part 34 and an outer part 36, the inner part 34 having the boss 22, the eyelet 16, the central channel 24 and the threaded opening 26. The outer part 36 is adapted to surround and house the inner part 34, and has the sleeve 18 and its own opening 40. The opening 40 is significantly larger than the opening 26 and in use overlies the opening 26. The opening 40 is formed through a section of the outer part 36 which is tapered, the component 10 being tapered (as is the component of WO 2008/071997) in order to enable the insertion of a replacement pipe of larger diameter than the existing pipe if desired. In addition, the trailing end of the outer part (i.e. the end adjacent the eyelet 16) is cylindrical with a substantially uniform diameter whereby to form a hole with as smooth a surface as possible and enable the replacement pipe to be more easily pulled into the hole.

The inner part 34 and outer part 36 are secured together by way of cooperating threaded sections 42, 44. The threaded sections permit the inner part 34 and the outer part 36 to be separated by the user if required, but it is intended that the inner part 34 and outer part 36 will be connected together by the manufacturer, and not separated by the user. It will be observed that once the nipple 32 is fitted the rotation of the outer part relative to the inner part is prevented, and it is intended that the component would be supplied to the customer with the outer part 36, inner part 34, cable 14 and nipple 32 assembled together, so that the component 10 is ready for use.

The cooperating threaded sections 42, 44 are adapted to form an airtight seal, perhaps with the addition of annular sealing members if required. It is desirable that the threads are sealed so that settable fluid and air cannot leak through the threads in the event that the seal between the existing pipe 12 and the boss 22 fails. If the threads are sealed the component 10 can only leak settable fluid or air if the seal between the pipe 12 and the boss 22, and also the seal between the pipe 12 and the sleeve 18, both fail.

It will be understood that neither the component 10, nor the inner part 34, can pass through the pipe 12, and so the cable 14 is fed along the pipe 12 from the “component 10 end” of the pipe 12 to the “winch end” of the pipe 12.

One method of removing a pipe 12 using the component 10 will now be described (notwithstanding the similarity with the method described in WO 2008/071997) in relation to the removal of an underground lead water pipe 12 serving a domestic building (not shown). The pipe 12 has its ends exposed as set out above. The free end of the cable 14, i.e. that end which is not secured to the component 10, is passed along the pipe towards the winch, and is connected to the winch. The component 10 is driven forcibly (as by a hammer) onto the end of the pipe 12, sufficiently to deform the end of the pipe into sealing engagement with the boss 22 and the sleeve 18 (see for example FIG. 4). Alternatively, the winch can be actuated so as to apply tension to the cable and force the component 10 into sealing engagement with the end of the pipe 12.

A delivery pipe (not shown) for the settable fluid is connected to the nipple 32 and the chosen settable fluid is introduced through the central passageway 24, around the cable 14 and along the pipe 12. When the settable fluid has filled the pipe and started to pass out of the end of the pipe adjacent to the winch the delivery pipe is clamped shut whereby to stop the flow of the settable fluid.

It is not excepted to be necessary to seal the end of the pipe adjacent to the winch, and instead it is expected that the sealing of the delivery pipe, and the sealing of the end of the pipe 12 to the component 10, will prevent the ingress of air into that end of the pipe 12, and thereby retain the settable fluid within the pipe 12. Thus, the small gap between the cable 14 and the pipe 12 is expected to be insufficient to allow the surface tension of the settable fluid to be overcome, so that significant quantities of the settable fluid are not expected to leak out. However, that end of the pipe 12 can be temporarily sealed, for example by a suitable adhesive tape or the like, if desired, it being recognised that an air-tight seal is not required.

Whilst the settable fluid is hardening, the replacement pipe may be connected to the eyelet 16. For example, a hole may be drilled through the replacement pipe adjacent to its end, its end is then pushed into the annulus 46 between the inner part 34 and the outer part 36, and a bolt is passed through the drilled hole and the eyelet 16 whereby to temporarily secure the replacement pipe to the component 10.

When the settable fluid has set sufficiently to support the pipe 12 as it is removed, the winch is actuated, the cable forcing the component towards the right as drawn in FIG. 4, and thereby acting to compress the pipe 12 along its length and force it towards the winch. As the component 10 is pulled through the earth after the existing pipe 12, it increases the size of the hole through the earth in order to accommodate the (larger diameter) replacement pipe.

Typically, the nipple 32 and at least part of the delivery pipe are left in place whilst the pipe 12 is removed. The component 10, together with the cable 14 and the removed pipe 12 can be removed from the winch and disposed of, or can be sent for separation and recycling if applicable.

The improved component therefore enables the operator to quickly and effectively seal the end of the existing pipe prior to the introduction of the settable fluid. This avoids the requirement for the operator to provide a makeshift seal with adhesive tape or the like. The likelihood of a makeshift seal being effective against the leakage of settable fluid and/or entry of air is small, which is at least partially due to the fact that access to the component when it is fitted to the existing pipe is typically limited and awkward. Also, some of the settable fluids which can be used, and in particular those based upon polyurethane resins, dissolve some adhesive tapes.

The component can provide an effective seal even if the outer surface of the existing pipe is damaged, which is often the case. The known connectors will often not work with such pipes.

It will be understood that the outwardly tapering form of the boss 22 can be matched (or replaced) by an inward tapering on the inside of the sleeve 18 if desired. The tapering form allows the component 10 to fit different sizes of existing pipes 12, i.e. a single component 10 may be able to fit to a pipe 12 having an outer diameter in the range of around 15 mm to around 32 mm for example. This is particularly advantageous as the operator will not often know the diameter of the pipe which is to be removed before its ends are exposed, and will not want to carry a large stock of components suited to particular diameter pipes. In addition, a component 10 which is able span pipe diameters in the range of 15 mm to 32 mm can be used with larger-diameter pipes also, the user compressing the end of the larger pipe (with pliers for example) in order to fit the component. Thus, a single component can cover a range of diameters covering all of the pipes (in the UK) which might be removed with the present method and apparatus.

Despite its advantages, however, the component 10 is relatively cheap to manufacture, its cost of a few Pounds Sterling being sufficiently small to allow the operator readily to dispose of the component after a single use.

1. A component for use in a method of removing an underground pipe, the component being securable to a cable and having a sleeve for surrounding an end of the pipe, the component having an opening through which a settable fluid may be delivered into the pipe in use, a surface of the component being adapted to seal the end of the pipe.

2. The component according to claim 1 in which the sleeve surrounds a boss, the boss being sized to fit into the end of the pipe, and in which the sleeve provides an outer surface of a recess and the boss provides an inner surface of the recess.

3. The component according to claim 2 in which the boss has a channel which connects the opening to the inside of the pipe in use.

4. The component according to claim 2 in which the outer surface of the boss is tapered.

5. The component according to claim 4 in which the boss has a leading end which is of smaller diameter than the inside surface of the pipe to which the component is to be fitted, and a trailing end which is of larger diameter than the inside surface of the pipe.

6. The component according to claim 2 in which the outer surface of the boss is adapted to seal the end of the pipe.

7. The component according to claim 1 in which the inner surface of the sleeve is adapted to seal the end of the pipe.

8. The component according to claim 1 in which the opening is threaded whereby to receive a threaded nipple.

9. The component according to claim 1 formed in two parts.

10. The component according to claim 9 having an inner part comprising a central shaft and an outer part comprising a housing for the shaft, the housing having a tubular end which provides the sleeve.

11. The component according to claim 10 in which the inner part and outer part are connected together by way of cooperating threaded sections.

12. The component according to claim 10 in which the inner part is securable to an end of the cable.

13. The component according to claim 12 in which the inner part has a channel which is stepped to provide a smaller-diameter part adapted for securement to the end of the cable and a larger-diameter part for the passage of the settable fluid.

14. The component according to claim 10 in which opening is formed through the inner part, and in which the outer part has an outer part opening which is adapted to overlie the opening through the inner part.

15. An apparatus for use in a method of removing an underground pipe, the apparatus comprising a component according to claim 1, a tensile cable secured to the component, a winch for pulling the cable and thereby pulling the pipe from the ground, and a settable fluid for introduction into the pipe to support the pipe as it is being pulled from the ground by the winch.
